(19) United States
(12) Patent Application Publication
(10) Pub. No.: US 2014/0046926 A1
(43) Pub. Date: Feb. 13, 2014

(54) SYSTEMS AND METHODS FOR SEARCHING GENOMIC DATABASES

(71) Applicant: MyCare, LLC, (US)

(72) Inventor: Matt Walton, Westport, CT (US)

(73) Assignee: MyCare, LLC, Westport, CT (US)

(21) Appl. No.: 13/759,770

(22) Filed: Feb. 5, 2013

Related U.S. Application Data
(60) Provisional application No. 61/595,436, filed on Feb. 6, 2012.

(51) Int. Cl. G06F 19/00; G06F 17/30

(52) U.S. Cl. CPC G06F 19/363; G06F 17/30867
USPC 707/710

(57) ABSTRACT

The invention described herein solves the challenges encountered in searching for clinical and genomic information from multiple data sources. Systems, methods, and devices of the invention allow a user to search a number of dissimilar information sources simultaneously, and view, process, and perform correlations on the information. The invention uses faceted search to process clinical values, genomic data, subject characteristics, and population characteristics, thereby providing a user with an array of information useful for monitoring or improving the state of health of a subject or a subject population. The invention allows a user to evaluate clinical and research information in a subject-centric way, and analyze information at either the individual or the population level.

### CROSS-REFERENCE

This application claims the benefit of U.S. Provisional Application No. 61/595,436, filed on Feb. 6, 2012, which is incorporated by reference herein in its entirety.

### BACKGROUND

Most health care data and research systems have evolved to support specific departments or functions; not necessarily to simplify a physician's, researcher's or patient's need to (i) meaningfully reduce medical errors by offering physician(s)/researcher(s) access to a complete view of all of the information being collected on patients in multiple data silos between and within hospitals, physician's offices, laboratories, clinics, nursing homes, prisons, correctional facilities, and long term care services; (ii) improve the work flow of health care providers and researchers; and (iii) provide much-desired information to subjects and their families at every stage of the health care delivery and research processes. Health care facilities are commonly configured such that the emergency department, wards, laboratories, pharmacies, care givers and support persons are each supported by different systems, each configured to support the specific requirements of those functions, and not designed to be cross-functional or interoperable. Such deficiencies adversely affect the delivery of care to individual patients and the fluidity of clinical research, and impede the delivery and improvement of care across multiple subjects. Further, existing information systems provide no mechanism to incorporate the genetic or genomic information of a subject or a population into the clinical information setting, owing in part to the inability to store, organize, and search such expansive data sets efficiently and reliably.

### SUMMARY OF THE INVENTION

In some embodiments, the invention provides a method of identifying clinical trial candidates, the method comprising: a) submitting a first query comprising a phenotype to search a genomic database to provide a first search result comprising a genetic information associated with the phenotype; b) submitting a second query to search a medical records database, wherein the second query is based on the genetic information, to provide a second search result comprising a set of electronic medical records, wherein each electronic medical record in the set is associated with the genetic information; and c) selecting or rejecting a candidate for the clinical trial based on the electronic medical records, wherein the searches are performed by a computer comprising a processor.

In some embodiments, the invention provides a method of identifying clinical trial candidates, the method comprising: a) submitting a first query comprising a phenotype to search a genomic database to provide a first search result comprising a genetic information associated with the phenotype; b) submitting a second query to search a medical records database, wherein the second query is based on the genetic information, to provide a second search result comprising a first set of electronic medical records, wherein each electronic medical record in the first set is associated with the genetic information; c) submitting a third query to search the medical records database, wherein the third query comprises a clinical trial inclusion criterion, to provide a third search result comprising a second set of electronic medical records, wherein each electronic medical record in the second set is associated with the clinical trial inclusion criterion; d) applying a logic operation to the first set of electronic medical records and the second set of electronic medical records to provide a final set of electronic medical records; and e) selecting or rejecting a candidate for the clinical trial based on the final set of electronic medical records, wherein the searches are performed by a computer comprising a processor.

### BRIEF DESCRIPTION OF THE FIGURES

FIG. 1 illustrates a non-limiting embodiment of a search system of the invention.

FIG. 2 illustrates the flow of information through an illustrative system of the invention.

FIG. 3 illustrates a non-limiting example of a system of the invention including a federated search model.

FIG. 4 illustrates the flow of a subject's information through an illustrative system of the invention.

FIG. 5 is a block diagram illustrating a non-limiting embodiment of a faceted search system.

FIG. 6 is a block diagram illustrating a first example architecture of a computer system that can be used in connection with example embodiments of the present invention.

FIG. 7 is a diagram illustrating a computer network that can be used in connection with example embodiments of the present invention.

FIG. 8 is a block diagram illustrating a second example architecture of a computer system that can be used in connection with example embodiments of the present invention.

FIG. 9 is a Venn diagram illustrating the intersection of clinical trial inclusion criteria as described in EXAMPLE 1.

### DETAILED DESCRIPTION

The invention disclosed herein overcomes historical obstacles against accessing, retrieving, transforming, and using health records and medical information by using faceted search technology combined with clinical support processes, algorithms, and care paths to make subject-centric and population-level information available to health care providers, researchers, patients and their families, caregivers, attendants, insurance providers, and those associated with the performance of health care tasks and clinical trials on both telecommunications devices and network or web-based access clients. The invention provides the access and organization of all relevant information for an individual subject or a group of subjects.

The invention described herein combines the foregoing advantages with the power of genomic medicine. Genomic medicine allows health care providers, researchers, subjects, record systems, laboratories, and insurance providers to find, share, distribute, analyze, and record the genomic information of a subject, a plurality of subjects, or a population of subjects. Genomic medicine improves health care outcomes by allowing health care providers to use a subject's genetic information to the subject's clinical advantage, and facilitates clinical research, for example, by identifying clinical trial participants via rapid genetic profile mapping.

The invention disclosed herein solves the daily challenge of providing physicians, researchers, caregivers, patients, and families with access to critical health information when, where, and how they need the information. The invention provides computer systems and methods for using the same, which can be accessed, for example, on a network or a telecommunications device via a medical dashboard by healthcare providers, researchers, patients and their families, caregivers, attendants, and those associated with the performance of health care tasks, research, insurance payment, and clinical trials. The instant invention organizes relevant subject information by screening institutional data silos to overcome the difficulties inherent in traditional integration approaches requiring custom interfaces, applications, conversions through proprietary or open standards, and/or database modification. Embodiments of the instant invention access data from all aspects of the relevant systems, and make data available in a user-formatted context that allows users to make better decisions and produce better clinical and research outcomes via improved searching.

The systems of the invention described herein provide rules and a query engine that improves the quality of genomic medicine initiatives by using faceted search to accelerate searching and rapidly explore all the information stored in multiple data sources without the need to copy the information to a host. The invention described herein provides a subject-centric, multi-platform, user-friendly tool to satisfy the needs, and enhance the performance, of health care providers and researchers using genomic medicine strategies. The invention conveniently, flexibly, and inexpensively allows users to conduct multi-variant (e.g. subject, provider, diagnosis, genetic signature, etc.) searches interfacing with any existing data source, for example, electronic medical records, electronic pharmacy records, medical histories, case studies, epidemiological studies, and clinical research databases.

The invention can search genomic databases of subject populations, which are either privately held or are in the public domain. The invention improves the clinical and research outcomes surrounding a subject by comparing the subject's genetic information with the genomic information of a population. The genomic information of the population can be associated with a phenotype, such as a condition or disease, or the probability of developing a condition or disease.

The invention provides a platform-independent analytic engine for finding, processing, and presenting clinical information in real time. The platform independent search engine can search for conditions of individual patients or groups of patients for hospitals, providers, and patients on databases that are privately held or in the public domain.

Genetic or genomic information of a subject or a population can take many forms. Non-limiting examples of genetic or genomic information include a gene; the probability of possessing a gene; a genotype; the probability of possessing a genotype; an allele; the probability of possessing an allele; a mutation; the probability of possessing a mutation; a polymorphism; the probability of possessing a polymorphism; a result of a restriction fragment length polymorphism test (RFLP); a result of a polymerase chain reaction test (PCR); a result of a paternity test; a nucleic acid sequence; the probability of possessing a nucleic acid sequence; the expression, penetrance, prevalence, copy number, pathway, function, or chromosomal location of any of the foregoing, and combinations thereof.

The invention allows medical staff to focus their time and energy on treating subjects rather than searching for subject health information, and similarly allows researchers to focus on health care improvements rather than reviewing clinical and genomic data by ineffective means. Thus, the invention improves work flow and productivity.

### Systems of the Invention.

The invention combines several means to access, retrieve, process, and display information from existing databases in an integrated application. Non-limiting examples of the means include: 1) the use of faceted search to access, retrieve, process, and display information or data from one or more existing information or data systems regardless of each system's schema for data and information; 2) the ability to perform context-free transformations using existing data structures instead of having to model two-way inter-record and/or intra-record transformations; 3) the ability to correlate data from a plurality of independent sources, regardless of their existing schema, based on one or more data points, wherein the existing schema of the sources may be the same schema for each source, or a plurality of schema; 4) the ability to create virtual documents with a shared context, which represent a collection of documents dynamically configured to meet user-defined requirements; and 5) the ability to query and present information in a form that meets a variety of user-defined requirements without the need for query tools to be able to interpret or reference a boundary descriptor or a format of the source data. In some embodiments, a system or method is effective to do all of 1)-5).

The result of the integration of any combination, or all, of these means is the creation of an application that can be quickly and easily applied to large, complex, multi-source data structures to access, retrieve, process, and display data and information. The invention provides users with context-relevant information without altering or interfering with any of the underlying data sources and structures. The invention permits users to define their own contexts for the display of information from multiple sources with the ability to set their own parameters for the extraction and display of the underlying data.

Systems of the invention can access, retrieve, process, and display data and information from a plurality of independent data and information sources. In some embodiments, the ability to access, retrieve, process, and display data and information from the independent data and information sources is independent of the schema of each source's data. In some embodiments, the device operating the system of the invention can access, retrieve, process, and display data and information from the independent data and information sources without directly mapping any portion of the device to a portion of the underlying data or information source. Non-limiting examples of data or information sources include healthcare record systems, such as a file, archive, legacy, database, or case history. The record system can be maintained by one or more clinics, hospitals, hospices, offices, private physicians, veterinary clinics, academic institutions, government agencies, private agencies, military agencies, correctional facilities, and insurance carriers. Non-limiting examples of data or information sources further include genomic databases of subject populations, which are either privately held or are in the public domain.

In some embodiments, at least one data or information source stores health records and/or medical information. The health records can contain genetic or genomic information about a subject, a plurality of subjects, or a population of subjects. Each instance of genetic information can be associated with a particular subject. In some embodiments, the genetic information of an individual can be isolated from a biological sample of an individual. The biological sample includes samples from which genetic material, such as RNA and/or DNA, can be isolated. Non-limiting examples of such biological samples include blood, hair, skin, saliva, semen, urine, fecal material, sweat, buccal, and various bodily tissues. Tissues samples can be directly collected by the individual, for example, a buccal sample can be obtained by the individual taking a swab against the inside of their cheek. Other samples such as saliva, semen, urine, fecal material, or sweat, can also be supplied by the individual themselves. Other biological samples can be taken by a health care specialist, such as a phlebotomist, nurse or physician. For example, blood samples may be withdrawn from an individual by a nurse. Tissue biopsies may be performed by a health care specialist, and commercial kits are also readily available to health care specialists to efficiently obtain samples. A small cylinder of skin may be removed or a needle may be used to remove a small sample of tissue or fluids.

An independent data or information source, data structure, or data system can be characterized by a scheme for the organization or coding of data. Within a plurality of independent data sources, data structures, and/or data systems, the independent data sources, data structures, and/or data systems can have the same schema, similar schema, dissimilar schema, different schema, or schema that are mutually incompatible. A system of the invention can perform any function described herein on any plurality of independent data or information sources, data structures, and/or data systems regardless of the varying natures of the schema characteristic of the independent data sources, data structures, and/or data systems. For example, a system of the invention can access, retrieve, process, and display data from a plurality of independent data or information sources, data structures, and/or data systems having the same schema, similar schema, dissimilar schema, different schema, or schema that are mutually incompatible. The independent data or information sources, data structures, and/or data systems can be searched simultaneously or sequentially.

In some embodiments, systems of the invention can perform context-free transformations using data and information from the independent data and information sources. In some embodiments, the system does not need to model two-way inter-record and/or intra-record transformations. In some embodiments, the system can use read-only caches of external data, wherein the system uses simple data type conversions instead of having to model two-way inter-record and/or intra-record transformations. A read-only cache can be temporary, and can be generated in response to the most recently input query.

Systems of the invention can correlate data and information from a plurality of independent data and information sources. In some embodiments, the ability to correlate data and information from a plurality of independent data and information sources is independent of the source schema. The schema can be the same schema for each source, or a plurality of schema.

In some embodiments, the data to be correlated is generated by exome and/or whole genome sequencing. Nucleic acid sequencing can be done on automated instrumentation. Sequencing experiments can be done in parallel to analyze tens, hundreds, or thousands of sequences simultaneously. Non-limiting examples of sequencing techniques follow. 1) In pyrosequencing, DNA is amplified within a water droplet containing a single DNA template bound to a primer-coated bead in an oil solution. Nucleotides are added to a growing sequence, and the addition of each base is evidenced by visual light. 2) Ion semiconductor sequencing detects the addition of a nucleic acid residue as an electrical signal associated with a hydrogen ion liberated during synthesis. A reaction well containing a template is flooded with the four types of nucleotide building blocks, one at a time. The timing of the electrical signal identifies which building block was added, and identifies the corresponding residue in the template. 3) DNA nanoball uses rolling circle replication to amplify DNA into nanoballs. Unchained sequencing by ligation of the nanoballs reveals the DNA sequence. 4) In a reversible dyes approach, nucleic acid molecules are annealed to primers on a slide and amplified. Four types of fluorescent dye residues, each complementary to a native nucleobase, are added, the residue complementary to the next base in the nucleic acid sequence is added, and unincorporated dyes are rinsed from the slide. Four types of reversible terminator bases (RT-bases) are added, and non-incorporated nucleotides are washed away. Fluorescence indicates the addition of a dye residue, thus identifying the complementary base in the template sequence. The dye residue is chemically removed, and the cycle repeats.

Systems of the invention are able to correlate search results regardless of whether or not the user intended for the results to be correlated, thereby identifying correlations that are unexpected, surprising, and useful to the user. Non-limiting examples of means of finding correlations include logic, language, clinical history, previous search results, inference, medical diagnosis, health care knowledge, nucleic acid sequence homology, copy number, polymorphisms, including single nucleotide polymorphisms, haplotypes, diplotypes, genotype, phenotype, gene nomenclature, accession numbers, and serial numbers. For example, searching for information on a subject characterized by both an indication and specific drug tolerances could return search results identifying an appropriate therapy directed towards that indication that was used successfully in other patients with similar drug tolerances. Further, the system could identify genetic similarities among the subjects in whom the drug had been used successfully, and identify a possible genetic signature associated with the therapeutic success of the drug. The genome of a subsequent subject can be compared to the genetic signature to make a prediction of the likelihood of successful therapy with the same drug in the subsequent subject. By searching the genetic information of a population of subsequent subjects, for example, a population of patients in a health care facility, the system can identify subjects suitable for therapy with the same drug.

Systems of the invention can query and present data and information without the need for query tools to be able to interpret or reference a boundary descriptor or a format of the source data or information. The data and information can be presented in a user-defined format, in a standardized format, a template format, or an institutional format.

Systems of the invention can create virtual documents with a shared context, which represent a collection of documents dynamically configured to meet requirements defined by a user, a superuser, or an institution. Systems of the invention can create or provide clinical and research documentation via prompts.

An unexpected result of the invention is the ability of a system of the invention to capture a stream of data or information from one or more data or information sources without the need to map, store, or mirror the data from the source onto a device operating the system. In some embodiments, the device does not internalize data from a data source. In some embodiments, the abilities of the device are independent of the nature or number of schema used by a plurality of data sources. The ease and speed at which the system of the invention can be incorporated into an existing health care system is faster than one would expect based on knowledge of modern search technologies.

In some embodiments, a system of the invention autonomously and periodically scans streams of data and information, and identifies changes in the data and information stored in a database. The system can search with or without a direct order from a user. A user can create search terms to be used once, repeatedly, or periodically. The system of the invention can scan, for example, once, continuously, daily, hourly, several times an hour, or every minute if the user desires.

The system can maintain a record of recent or historical search queries and rules, and correlate those searches to, for example, a user, a subject, a health condition, a diagnosis, a prescription, a medical order, a health care facility, an experiment, a clinical trial, or any combination of the foregoing. The system can also correlate the search queries and rules to genetic or genomic information. Thus, the system can repeat previous searches to provide updated information, and if desired by the user, automatically compare new search results with the previous search results. The user can instruct the system to update a search periodically using the same or modified search queries and rules and make qualitative and quantitative comparisons of the search results periodically. Such update searches can self-execute even if the user is not concurrently engaged with a client device that operates the system. For example, a user, such as a physician or researcher, can instruct the system to alert the physician or researcher every time a certain patient is administered a medication, the amount of the medication, historical administration of the medication, potential side effects or incompatibilities with the medication, and past instances of adverse events to the medication. The search can also provide other forms of information, triggered by the search terms used, that are not necessarily the search results that one would have expected. This aspect of the invention provides the user with the opportunity to access information that the user might not have realized was available or relevant, and the user can make a professional judgment regarding the use of the unexpected search results. This aspect of the invention also ensures that the scope of the search results are not strictly limited by the searching skill and techniques of the user, and that important information does not go undiscovered by a novice user.

A system of the invention can archive the searching, querying, or data browsing activities performed on devices associated with the system. The archive can be searched in future searches to provide more rapid search results when search terms are repeated in the future and to notify the user of instances in which similar searches had been executed in the past. The archive also provides historical information, which can be used to monitor searching, querying, or data browsing activities over time. The searching, querying, or data browsing activities of a healthcare or research institution can be entered into the archive, either automatically or manually, to provide searchable data. Non-limiting examples of searching, querying, or data browsing activities entered into the archive include any activity described herein.

Systems of the invention can be used in a hospital or research setting. In some embodiments, the invention is used outside a hospital or research setting. In some embodiments, the invention is used in a subject's home, and can allow communication between a hospital and a subject's home. Non-limiting examples of sites where systems of the invention can be used include a hospital, a satellite clinical and care management facility; a nursing facility; a hospice and palliative care facility; a clinic; an ambulatory surgery center; a temporary emergency off-site facility; a laboratory; a clinical trial site; a government institution; and a correctional facility.

A system of the invention can support any number of users, who can be, for example, physicians, clinicians, patients, caregivers, attendants, researchers, or security personnel. Each user can create a user profile, and edit the profile at any time. Non-limiting examples of fields incorporated into a profile include: name, title/position, department, specialty, login identification, password, work schedule, associated patients, and current location.

A system of the invention can support a faceted search as a method to identify, for example, diagnosis, prognosis, drugs currently being prescribed, and treatments received. A particular query is received, and various facet-filters designed by the method of the invention are applied to generate a summarized list identifying individuals based on the query criteria.

In some embodiments, one or more superusers can create, access, and/or modify any user profiles. A superuser can be a person with supervisory authority over the users, for example, the head of a clinical department, head of research, director of a clinical trial, head of security, or head of an information technology program.

In some embodiments, the invention is designed to be compliant with both data interoperability and security standards. The invention recognizes and supports the mandate that Electronic Health Records (EHRs) should be safely and securely accessible as Personally Controlled Health Records (PCHRs) by patients and their physicians. Consequently, some embodiments of invention are compliant with HL-7 as well as commercial Web standards to permit sustainable cross-platform data access. In some embodiments, the invention is HIPAA compliant.

Aspects of the invention provide improvements in healthcare via both direct delivery of care and improved clinical research productivity. The invention supports, for example, diagnosis, treatment, decision-making, monitoring, research initiatives, subject identification, selection of clinical trial candidates, and genetic and genomic comparisons, thereby improving outcomes. Non-limiting examples of improvements include better patient outcomes; decreased cost of healthcare through reduction in medical errors, length of hospital stays, re-admissions, redundant tests and procedures; more accurate billing; increase in physician, patient and provider satisfaction; increase in revenue through prompted and more accurate coding; increase in efficiency of medical staff through improved access to information, capacity to prioritize, and access to alerts and updating functions; improved planning of research endeavors such as clinical trials; improved understanding of clinical research results; faster pace of taking a lead drug candidate though the clinic and into market; and overall improvement in clinical outcomes.

The invention supports pandemic response and large-scale disaster management, facilitating patient identification, triage, treatment and tracking, for example, by using personal, clinical, or genetic information.

The invention can reduce the cost of health care locally, regionally, or nationally, both by improving the efficiency of health care delivery and by attenuating the costs of clinical research, thereby leaving the researchers with smaller costs to recover through sales. In some embodiments, the invention reduces risk to the subject, thereby reducing the costs associated with malpractice suits and insurance premiums. The invention can facilitate access to funds available for services provided.

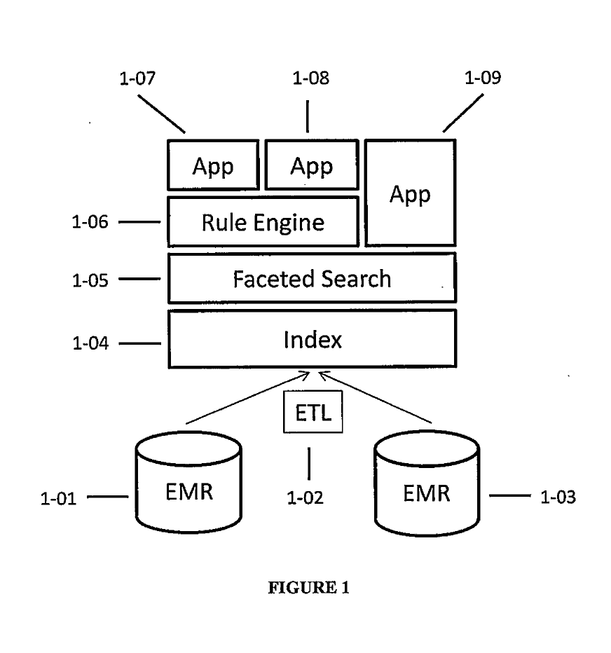

FIG. 1 illustrates an example of a system of the invention. The system continually extracts data from one or a plurality of electronic medical records (EMRs; 1-01 and 1-03), transforms the data, and loads the data into the index (1-04). The extract-transform-load pathway (ETL; 1-02) is portrayed as arrows connecting the EMRs to the index (1-04). The index (1-04) employs a flexible data model that allows efficient indexing and searching of the totality of clinical data from the EMRs. The data elements are associated with individual subjects. The faceted search engine (1-05) allows users to filter subjects by multiple facets, which can be pre-determined, or adjusted, by the user. The rule engine (1-06) creates rules, which can assign one or more tags to subjects. The rules are defined, for example, by taking the intersection or union of multiple faceted search queries, as determined by the user. Applications (1-07; 1-08; and 1-09) utilize the rule engine and faceted search features of the system. Applications can be coded into the system as modules, added as plugins, or developed independently by the user. The applications or modules of FIG. 1 can be, for example, any application or module described herein.

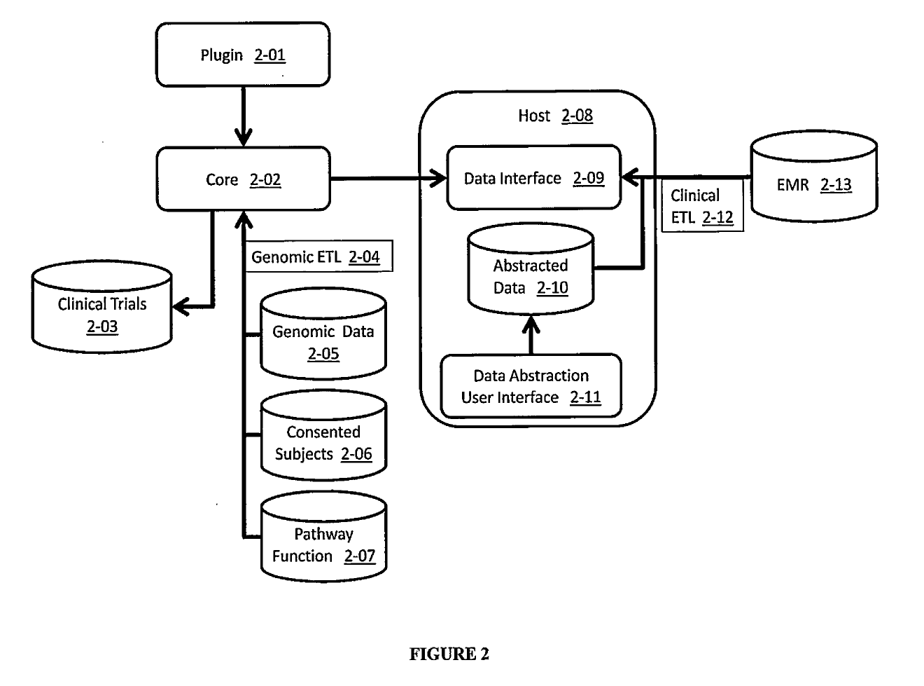

FIG. 2 illustrates a non-limiting illustrative embodiment of the exchange of information in a system of the invention. A user accesses the core (2-02) of the system via a plugin application (2-01). The core (2-02) has access to information including genomic data (2-05) stored in databases; the personal, clinical, and genetic and genomic information of consented subjects (2-06); and the scientific, literature, and art understandings of physiological pathway functions (2-07). The information is assimilated into the core (2-02) through an ETL process (2-04). The core (2-02) can use the available information to support clinical trials (2-03), for example, in subject selection.

The core (2-02) communicates with a host (2-08), such as a hospital, clinic, or laboratory. The host (2-08) maintains a data interface (2-09), which can collect information from local sources, and relay the information to the core (2-02). The local sources include abstracted data (2-10) produced by a data abstraction user interface (2-11), and an EMR (2-13). The information produced is entered into the host (2-08) through an ETL process (2-12), and becomes available to the core (2-02).

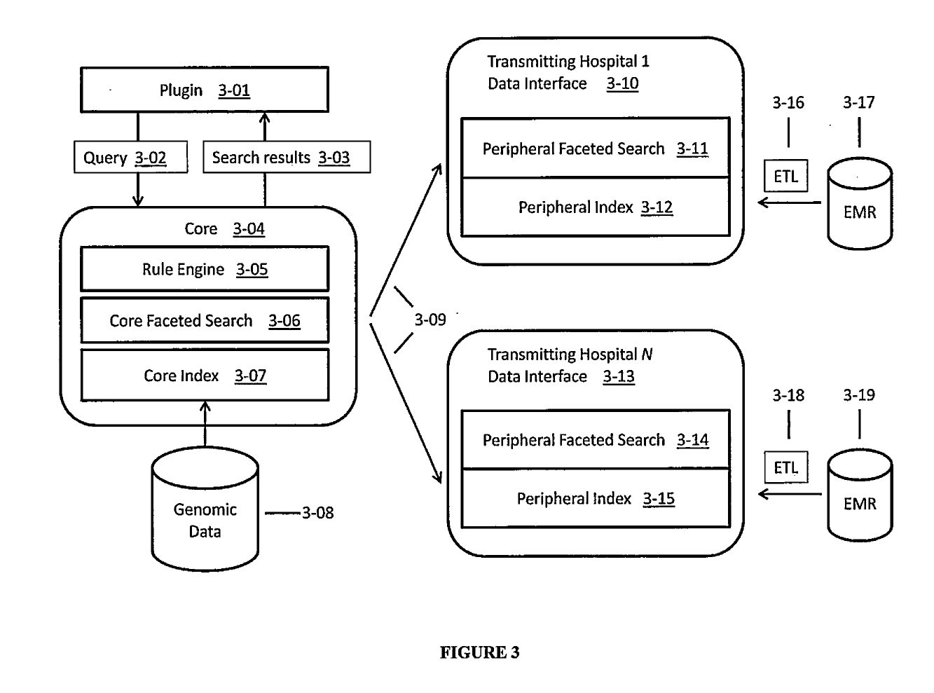

FIG. 3 illustrates a non-limiting illustrative embodiment of a core (3-04) and some number “N” of transmitting hospital data interfaces (3-10 and 4-13), operating in federation with the same core. A user inputs a query (3-02) to the core (3-04) via the plugin (3-01). The plugin application (3-01) provides a user interface component that allows a user access to the core (3-04). The plugin (3-01) need only communicate with the core (3-04) for successful operation of the system. The core (3-04) contains a core index (3-07), which can incorporate genomic data (3-08) of a population of subjects from genomic databases; a core faceted search engine (3-06), which can perform a faceted search of the core index (3-07) at the user's instruction; and a rule engine (3-05), which can execute rules, input by the user, on preliminary search output.

The core index (3-07) compiles all subjects' genomic data, and can execute faceted search queries on genomic data. Rules can combine the results of queries on genomic data with queries on clinical data. The core (3-04) retrieves information and data from transmitting entities based on the user's needs or commands, or based on pre-existing or recurring search criteria.

The core (3-04) can query information or data from as many as N transmitting hospitals by executing a federated query (3-09) against one or more transmitting hospitals via the core faceted search engine (3-06). The federated search (3-09) allows a query to be distributed and searched by multiple participating search engines, which return search results back to the original system, in this case, the core (3-04).

The data interface provides access to information and data stored, house, or recorded at a site such as a hospital, clinic, silo, database, or other facility managing EMRs. The core (3-04) executes faceted searches against the data interfaces. Data interfaces can exist at any institution that need to submit search queries, such as a hospital, clinic, or laboratory. Alternatively, such institutions can access a data interface via managed hosted environment under the control of the institution, but hosted by a site that stores the genomic information, which acts as a hub.

Each transmitting hospital hosts a data interface (3-10 and 3-13), each under the control of the respective hospital. Each data interface contains a peripheral faceted search engine (3-11 and 3-14) and a peripheral index (3-12 and 3-15). The peripheral index of transmitting hospital 1 (3-12) can incorporate all data and information, including genetic and genomic information, contained in the electronic medical records (EMR; 3-17) at transmitting hospital 1 through an extract-transform-load process (ETL; 3-16). For example, the EMRs can describe subjects who have received care at transmitting hospital 1. Similarly, the peripheral index of transmitting hospital N (3-15) can incorporate all data and information, including genetic and genomic information, contained in the EMRs (3-19) at transmitting hospital N through an extract-transform-load process (ETL; 3-18).

A federated query (3-09) submitted by the core (3-04) to the transmitting hospitals can instruct the peripheral faceted search engines (3-11 and 3-14) to search for information stored in EMRs (3-17 and 3-19). The information is returned to the core (3-04), where the rules engine (3-05) can apply any rule input by the user to the information drawn from the EMRs (3-17 and 3-19) and the genomic data (3-08). The final search results (3-03) are returned to the user.

This architecture provides a system that functions without the need to store information or data at the site of the user. Retrieved information and data can flow transiently through the system.

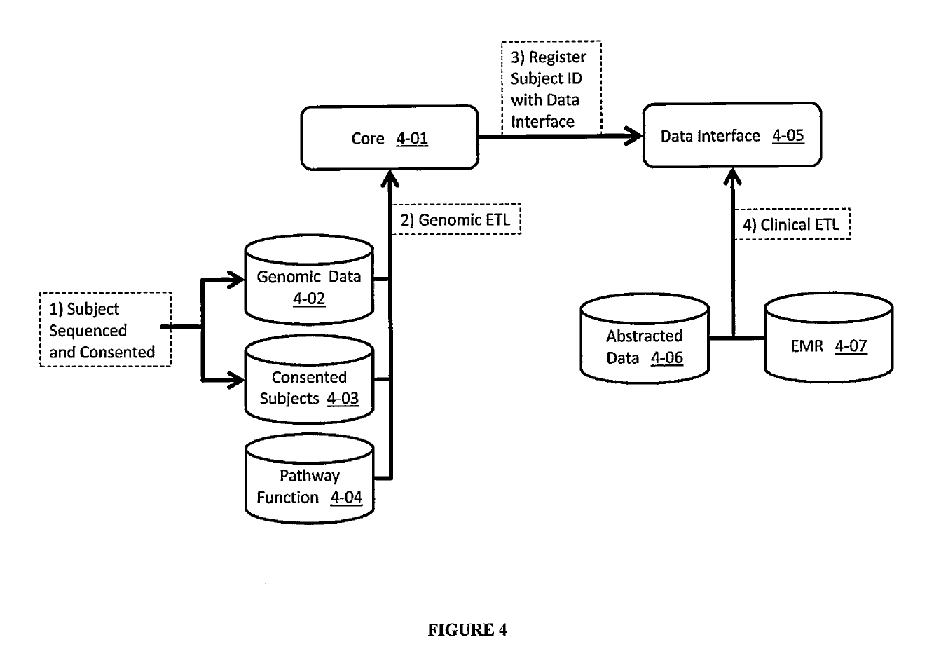

FIG. 4 illustrates a non-limiting illustrative embodiment of a process by which a system of the invention can gather information and data about a particular subject. In step 1, the subject consents to genomic sequencing and is sequenced. The sequencing can be performed by any method known in the art, for example, based on a tissue sample such as blood. The subject is then catalogued as a consented subject (4-03), and the subject's genetic and genomic data are entered into a genomic database (4-02). The information gathered from sequencing can be combined with scientific, literature, and art understandings of physiological pathway functions (4-04), and all the resultant information can be entered into the core (4-01) at step 2, which performs an ETL of all genomic information made available in the foregoing process.

In step 3, the subject is registered with the data interface (4-05), which can be hosted at an institution possessing clinical, genetic, or genomic information. The data interface (4-05) is able to collect data and information from abstracted data (4-06) and EMRs (4-07). The information collected could have been tagged, for example, by the subject's personal identity or by genetic or genomic information associated with or similar to that of the subject, such as a genetic signature. The resultant information is made available to the data interface in step 4, which performs an ETL of clinical information.

### Searching of Electronic Medical Records and Genetic and Genomic Information.

The systems and methods described herein provide superior treatment outcomes by comparing genomic information from a subject to the genomic information from a population. The genomic information from the population can be correlated with a gene, an allele, a nucleic acid sequence, a mutation, a function, a pathway, a copy number, a polymorphism, a phenotype, a probability of possessing a gene, a probability of possessing an allele, a probability of possessing a nucleic acid sequence, a probability of possessing a mutation, a probability of possessing a function, a probability of possessing a pathway, a probability of possessing a copy number, a probability of possessing a polymorphism, a probability of possessing a phenotype, or a probability of developing a phenotype. The genomic information from the subject can then be correlated with an allele, a phenotype, a probability of possessing an allele, a probability of possessing a phenotype, or a probability of developing a phenotype, based on the comparison between the genomic information from the subject and the genomic information from the population.

The invention allows a user to identify genomic similarities among subjects and review treatment and outcome information to improve treatment of a subject. Users can search, for example, by gene, allele, nucleic acid sequence, mutation, polymorphism, copy number, pathway, gene function, or phenotype. The genomic database stores the genomic variant, such as a mutation, and associated pathway, function, and driver information. The pathway information describes all pathways to which genetic information is relevant, using public and/or private pathway databases. The function information describes all functions that a gene has, using public and/or private databases. The driver information describes a flag that marks a mutation specifically as a known cancer driver. Expanding the data associated with a gene in this manner improves the development of queries. Instead of querying for specific mutations, users can query for mutations based on pathways, function, or other information associated with the mutation, which can be updated as new knowledge sources are added.

The comparisons described above provide an insightful entry into clinical research. The ability to associate a genotype with a phenotype in a population of subjects allows the prediction of a corresponding phenotype in a subject possessing the same genotype. Such comparisons can be used to identify subjects who are candidates for therapy, and draw correlations between subject genotype and the efficacy of therapy.

The invention combines the ability to search for genetic and genomic information with the ability to search simultaneously or sequentially for clinical information. A user of the system can define queries to search databases and other data and information sources for clinical data and information and genetic or genomic data and information. Queries can be tailored towards a particular search or generalized based on the needs of the healthcare provider or researcher.

The user can define rules, which operate on the search results retrieved by the queries. For example, a rule can apply Boolean logic to a set of search results. A rule can be implemented to control search parameters, reporting of results, and alerts issued by the system to a user or subject.

The taxonomy hierarchy facilitates selecting a candidate for a clinical trial based, for example on electronic medical records. For example, searching for the phenotypic trait “obese” in a first query is a one-faceted query of a medical records database. Searching for the phenotypic trait “obese” and the phenotypic trait “blood type A” is a two-faceted query search of a medical records database. The system of the invention can accommodate any number of queries.

The taxonomy depth of the system of the invention provides the user with search options at varying levels of vertical precision. Submitting a query, for example: “Type-2-Diabetes”, avails depth by accessing search options associated with Type-1-diabetes at a greater level of specificity. For example “Type-2-Diabetes”, can be associated with terms, such as “obese”, “increased thirst”, and “blurred vision”. Submitting further queries provides more precise search results which can lead more directly to records characterized by phenotype and genetic data.

The taxonomy depth of the systems of the invention allows a third query search of the medical records database, wherein the third query comprises a clinical trial inclusion criterion. A user can perform a first query search for “obesity”, a second query search for “Type-2-Diabetes”, and a third query search for “18-years-old and older”.

The taxonomy breadth of the system of the invention can accommodate any number of query searches at any taxonomy depth. A user can search, for example, for a disease, a symptom, a therapy, and a drug. A user can also search, for example, for “cancer”, “breast cancer”, “metastatic breast cancer”, and “breast lump”, “pain”, “swelling”.

The logic operations used by the system of the invention can be expressed in many kinds of notation, including, for example, natural languages, pseudocode, flowcharts, programming languages, or control tables.

The logic used by the system of the invention allows the user to search for truncations. Truncations, for example *diab*, allows users to retrieve records containing “diabetes”, “diabetic”, “diabetis mellitus”, and a plurality of terms containing the truncated words.

The logic used by the system of the invention can include and/or exclude any number of values. For example a user can search for: a) “diabetic” AND “obese”, b) “diabetic” OR “obese”, c) “diabetic” AND “obese” AND “caucasian”; or d) “diabetic” OR “obese” AND “Caucasian”.

One output of the system of the invention can be a list of individuals defined by the parameters of a query search. Another output can be a list of events. Non-limiting examples of a list of events include: a) a list of medications prescribed to a group of individuals in a given month; b) a list of clinical trial enrollments by a physician; and c) a list of scheduled surgeries in a given hospital.

The output of the system of the invention can be viewed on smartphone(s), tablet(s), desktop computer(s), laptop computer(s), and a plurality of mobile devices with a plurality of different operating systems. The user can review electronic records, and genetic and genomic information by accessing the interface of the system of the invention. A system of the invention can archive the data on a centralized data source for future reference. A system of the invention can archive data on the device being used to access the interface of the invention.

A system of the invention provides a convenient and reliable method whereby a healthcare provider or researcher can track all subjects currently served or monitored by the provider or researcher, and check each subject's schedule of upcoming events. The system provides the provider or researcher with options and reminders for tasks to perform at the arrival, departure, or discharge of a certain subject, any subject with a certain indication, or any subject participating in a clinical trial. For example, the system can provide a reminder to ask the subject if a prescription needs to be refilled.

A user can browse a list of subjects served by a certain healthcare or research facility. The user can add new subjects, edit the profiles of the existing subjects, or delete old subjects, as is appropriate for maintaining accurate clinical and research records in accordance with the prevailing regulations.

A user can search for, generate, and browse a list of all encounters that a subject has had with healthcare providers and researchers or other support staff at the healthcare or research facility. The user can examine these records to evaluate the subject's current status and assess what the subject needs in the forthcoming encounters and what research information should be gathered from or about the subject.

A user can build a healthcare or research regimen for a subject using a system of the invention. A regimen, broadly, encompasses the medications, medical orders, procedures, encounters, and schedules describing the treatment, observation, and care of a subject. The user can search for therapies corresponding to a subject's diagnosis, or search for therapies that are currently in use for the same diagnosis at the user's healthcare facility or another facility. The user can search for therapies corresponding to a subject's genetic or genomic information, and use the information to plan a therapy or research initiative, for example, based on the case histories of other subjects with similar genetic or genomic information. The system can provide a list of healthcare or research options, and the user can build a regimen for the subject simply by scrolling the list and clicking icons to add the options to the subject's regimen. The subject's regimen appears in a new file associated with the subject's profile, and the regimen is accessible to all users on the same network. Other users with permissions to modify a regimen can modify the regimen and make changes to the file. All changes made are visible to all users. The fast and flexible ability to add, share, and distribute information facilitates the organized and timely performance of healthcare and research tasks.

Searching for a specific therapy can provide the user with a list of therapies similar to that which was searched. Alternatively, searching for particular genetic or genomic information can provide the user with a list of therapies or subjects associated with the genetic or genomic information that was searched. Such search results can provide the user with healthcare and research options that the user might not have known were available, thereby providing the user with a greater scope of alternatives and a higher probability of identifying a desirable outcome or productive course of action. For example, a user can search the system for information on a medication, or for a list of equivalent medications. Equivalent medications are expected to provide similar clinical outcomes upon administration, but might be associated with different allergies, drug interactions, and side effects. Equivalent medications might also be known to interact favorably or unfavorably with subjects characterized by certain genetic or genomic signatures as catalogued in a genomic database. The ability of the system to provide the user with a list of alternative medications increases the likelihood of identifying the best possible medication for the subject at hand, in some cases, based on a comparison of the subject's genetic or genomic information against a genomic database. In this regard, the system allows the user to focus a search strategy on a subject, whereas conventional search methods focus on a condition or indication.

A user can search, for example, for clinical values for one or more subjects, for subject characteristics, and for population characteristics.

Clinical values broadly describe information surrounding clinical procedures and observations. A clinical value can be any data that can be used to describe and/or assess the general state of health of a subject. Non-limiting examples of clinical values include: blood pressure, pulse, pulse oximetry, cholesterol level, blood sugar, respiration rate, weight, strength, metabolism, and changes in any of the forgoing.

Subject characteristics broadly encompass information describing a subject of interest to a user of a device of the invention, the subject being a human, for example, a patient or relative, associate, or representative thereof. A subject characteristic can be any information that describes the general status of a subject, such as a patient. Non-limiting examples of subject characteristics include: clinical values; demographic information; personal information such as, name, date of birth, date of admission, date of discharge, etc.; indications; past indications; prescriptions; medical orders; and genetic and genomic information, such as a genetic signature, a gene, an allele, a genotype, a phenotype, a mutation, a polymorphism, a genetic function, or a pathway.

Population characteristics broadly encompass information describing a population of patients or subjects, for example, associated with a health care institution or provider or patient demographics. A population characteristic can be any subject characteristic considered more generally for a population of subjects and optionally analyzed statistically. Non-limiting examples of populations that can produce population characteristics include: current subjects in a facility; past subjects in a facility; subjects entered into a database; subjects registered with a clinical trial; a population of a defined geographic region; and a population defined by a specific characteristic, such as age, prescriptions, diagnosis, complaints, symptoms, indications, genetic information, genomic information, phenotypic information, etc.

A user can assign a threshold level to a clinical value or characteristic of a subject. The clinical value or characteristic can be monitored by conventional means, such as by a medical monitoring device, and entered into a health care database by conventional means. Upon scanning the data system, a system of the invention obtains the new identity of the value or characteristic and alerts the user when the threshold level has been met. Thus, the system provides close and conscientious monitoring of values and characteristics by passive, non-intrusive, convenient means. Non-limiting examples of an alert include: a visual alert, such as a colored and/or flashing/blinking light; an audible alert; such as a tone or a prerecorded voice message; and a textual alert, such as an e-mail or a text message.

Non-limiting examples of medical monitoring devices compatible with systems of the invention include: blood pressure units, pulse oximeters, oxygen concentrators, glucometers, thermometers, infusion equipment, IV delivery devices, suction machines, portable oxygen units, and continuous positive airway pressure devices.

For example, a physician monitoring a subject's blood pressure can determine a threshold level for the subject's blood pressure. The subject's blood pressure is monitored by conventional methods and the blood pressure value is periodically entered into a medical database. Each time the system of the invention scans the database, the system observes the most recent blood pressure value, and optionally, trends in blood pressure values. The physician can pre-determine a threshold value for the patient's blood pressure, and request notification when the blood pressure reaches that threshold. When the blood pressure reaches the threshold level, the system notifies the physician. This capability allows a user, such as a physician, to become aware of a value or characteristic that the physician might not be actively monitoring or even perceive as an immediate risk factor.

Similarly, as subject laboratory data become available, the physician, researcher, or other user can become aware of results of tests that were run without the user's knowledge. Thus, the system can provide the user with potentially useful information that the user might not know is available or critical.

Systems of the invention provide the opportunity to monitor quality measures, in both clinical and research settings. Quality measures in the clinical setting identify classes of subjects, and identify interventions that can be performed for each subject class. For example, all subjects with Acute Myocardial Infarction (AMI) must receive aspirin within twenty-four hours of arrival at a hospital. A core measures application can apply rules used to tag subjects to which quality control measures are applicable. Rules also determine if the quality control measures have been fulfilled, failed, or if the status is unknown. Users can review subjects, classes, and the status of each measure, and take action if needed. In doing so, the user can make better healthcare decisions, or become more informed of the status of a clinical experiment.

Systems of the invention can provide patients, physicians, health care providers, and caregivers with information regarding drug resistance and/or susceptibility. Methods of the invention allow the user to search for genomic databases and medical records for information such as genes, alleles, single nucleotide polymorphisms, haplotypes, diplotypes, karyotypes, gene copy number, gene expression levels, phenotypes and medical diagnoses associated with drug resistance and/or susceptibility. A non-limiting example of the application of the invention in identifying drug resistance/susceptibility markers includes the identification of variants of the Abelson tyrosine kinase (ABL) gene. Mutations in the Abl gene can lead to Chronic Myeloid Leukemia (CML), and single nucleotide polymorphisms can render subjects resistant to treatment with Gleevec. In this regard, the system allows the user to search increasingly more annotated genetic and genomic data based on genetic details, not merely based on conventional medical documentation, to focus the search strategy on identifying drug resistance and/or susceptibility markers.

Systems of the invention provide a faceted search of genomic databases to identify particular genetic signatures. Non-limiting examples of databases that can be searched by the method of the invention include the National Human Genome Research Institute (NHGRI), the NIH National Center for Biotechnology Information (NCBI), the publicly-accessible Personal Genome Project (PGP), the databases in the European Bioinformatics Institute, and a plurality of privately-held electronic medical records.

A system of the invention can be used to view an individual's medical records on smartphone(s), tablet(s), desktop computer(s), laptop computer(s) and a plurality of mobile devices instantly upon documentation within an electronic medical records system. This versatility dramatically facilitates the task of individual(s) and clinician(s) in their search to obtain medical intelligence on their patients.

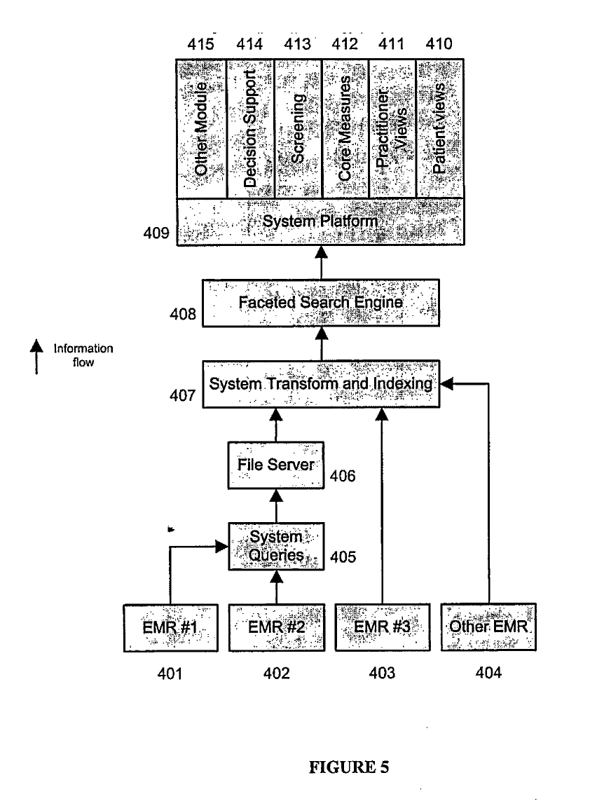

FIG. 5 depicts an illustrative, non-limiting embodiment of a faceted search system for subject clinical records, data, and information. FIG. 5 illustrates the flow of information from various information resources to the system platform. Information is accessible from a plurality of electronic medical record (EMR) systems (401; 402; 403; and 404). The EMRs can be in-house, or local, systems (401, 402, and 403), operated by the institution using the system of the invention, or can be an EMR located remotely (404), and administrated, owned, and operated by a different institution or entity. The different institution or entity can be a partner of the institution operating the system of the invention, or can be publicly-accessible. An EMR can be any kind of information or data system described herein.

System queries (405) represent search protocols designed to retrieve information from one or more EMRs. The information can be that which is needed or desired by the system platform or the user of the system platform, or can be information that the system or the user does not realize is beneficial, relevant, or available. System queries (405) can be designed to run at the user's direction, or at intervals. For example, a system query can be queued to run a baseline query daily and partial queries at preset intervals determined by either the user or the system platform.

Results of the system queries (405) are sent to a file server (406), where the results can be stored for any length of time. The file server (406) can share the query results with any number of system platforms that have data-sharing privileges.

Information contained in the file server (406) is then subjected to system transform and indexing (407). Information can also be transformed and indexed directly from a local EMR (403) or a remote EMR (404) to provide direct HL7 feeds of medical, clinical, and administrative information. The transformation of data from the one or more data sources is a context-free transformation, and the transformed information is compiled into an index for the faceted search engine (408).

The faceted search engine (408) allows the user to execute search functions on the system, and can access all transformed and indexed information (407). Once the faceted search engine (408) has acquired search results, the results are sent to system platform (409), which is the platform for applications of systems of the invention.

The system platform (409) supports a variety of application modules (410-415). The modules provide the user with a variety of interface options and post-search processes. The patient view module (410) can be optimized to provide a patient with, for example, information that can assist the patient in evaluating the current state of health and sustaining or improving the quality of life. The practitioner view module (411) can be optimized to provide a healthcare practitioner with, for example, information pertinent to monitoring, evaluating, diagnosing, or caring for a patient or a population of patients.

The core measures module (412) allows a user to compare the treatment of a patient or a population against evidence-based, standardized performance measures.

The screening module (413) allows a user to screen information from the data sources rapidly without the need to know which data source provided the information.

The decision support module (414) provides a user with information and interpretations of information, for example, correlative graphs, useful for making a decision in a healthcare initiative. For example, the decision support module (414) can provide a physician with a list of medications that could be administered for a certain indication.

The other module (415) can be a user-defined application designed to optimize the acquisition, display, or processing of information, and is not limited to the embodiments described herein.

Context can describe, generally, the boundary descriptors or format information used in an information system to understand or interpret the data contained therein. Similarly, a context-free process can operate in the absence of aforementioned context. A context-free transformation can be any data transformation protocol executed in such a way that context is unnecessary. In some embodiments, a device or system of the invention can search for, transform, present, and/or correlate data without the need for the query tools to be able to interpret or reference a boundary descriptor or a format of one or more host systems. The ability of a system or device of the invention to query and present information in a user-defined format without the need for query tools to be able to interpret or reference a boundary descriptor or a format of one or more host systems can be thought of as the lack of a need for application code that understands the meaning or the original context of the source data.

Query tools, generally, can be any software system that allows a user to access information stored in a database, data system, or data source.

In some embodiments, the device creates virtual documents with a shared context, and can create a collection of virtual documents configured, or dynamically configured, to meet user-defined requirements, for example, a format, configuration, graph, table, plot, list, patient profile, population profile, user profile, statistical breakdown, inventory, timeline, or display. In some embodiments, the dynamic configuration allows multiple users to configure documents differently, or change the configuration of existing documents.

For illustrative examples of principles, methods, and applications of faceted search, see David Smiley & Eric Pugh, SOLR 1.4 ENTERPRISE SEARCH SERVER (Packt Publishing 2009), which is incorporated herein by reference in its entirety.

In some embodiments, the search system can be restricted by careful use of search parameters to limit or eliminate unexpected search results. A user can also modulate the level of the unexpected search results to find few, some, or many unexpected search results in addition to the desired, expected search results.

The interfaces associated with the system can be modified or customized to suit the preferences or proficiency of the user. Options for providing simple queries and rules allow users without extensive training in information technology to navigate the system and enhance their healthcare and research performance.

In some embodiments, the system can search reference materials. The reference materials can be medical, clinical, scientific, genetic, genomic, pharmacological, nursing, or veterinary reference materials.

In some embodiments, devices, systems, and methods of the instant invention provide the ability to access, retrieve, process, and display the aspects described in Table 1. Table 1 lists non-limiting examples of clinical values, population characteristics, and subject characteristics.

TABLE 1
Access to underlying data
Context-driven access to relevant information by user type; user types
include: Department Head; Hospitalist; Primary Care Provider; Specialist;
Nurse; Patient; Patient family; Caregiver; Security
Thin client data access - no data resident on user device
Multi-level HIPAA compliant password-protected security
Physician context-driven access
Full patient list ranked by severity
Initial full patient display with critical vital sign information including:
temperature; blood pressure; pulse; pulse oximetry; and respiration rate
Individual patient detail, including: patient picture; age; known allergies
All vital signs color coded for abnormalities
All vital signs viewable as trended values based on user defined time
frames (for example, 24 hours, 48 hours, 72 hours, etc.)
All vital signs either normative, or physician-defined thresholds can be set
for specific vital signs and/or specific patients
Multiple vital sign trends can be selected by the user and displayed on the
same graph
All additional relevant biometric data can be accessed and displayed using
the methods described herein
Encounter report for access to all encounter-related information
Total alerts list with alert detail
Alerts driven by normative or caregiver specified values
Phone list showing all members of patient care management team with
telephone numbers with direct-dial functionality for: Primary Care
Provider; Specialist(s); Hospitalist; Nurse; Nurse's station
Direct-dial to dictation service with auto-fill for patient name, ID, and
if applicable, specific record
Ability to dictate physician and nursing notes for input into the patient
record
Possible diagnoses - list generated using algorithmic search; exemplary,
non-limiting suggested diagnoses include: chronic heart failure; anemia;
diabetes; and sepsis
Alert events list with access to user-defined trended information
Medications administered list showing: all medications from all sources
(multiple databases); last dose (amount and time); total doses administered
in previous 24 hours (number and cumulative amount); and total doses by
medication type during user-defined timeframe (for example, 24 hours, 48
hours, 72 hours)
Ability to render patient encounter information as a static document (for
example, .pdf format) for transfer to, for example: primary care provider;
specialist; nursing home; and Personally Controlled Health Record -
PCHR (for example, Microsoft HealthVault ™)
Search of all patient records regardless of data repository with appropriate
permissions
Access to multiple hospital database systems
Ability to make auto-dialed physicians and nurse's notes part of the
patient's record
Ability to semantically browse transcribed physicians and doctors and
nurses' notes for user defined information
Prompts for required and/or desirable physician and patient actions,
for example: smoking cessation; exercise/physical therapy; dietary
restrictions; prompts for appropriate coding and billing; possible
diagnoses; severity scales (with or without complications); ICD-9 codes;
prompts for comprehensive documentation for patient transfers and/or
discharges; medication lists/prescriptions; durable medical equipment;
physical therapy; and special orders and/or instructions
Permits remote independent physician data access to hospital data
systems
Facilitates patient information exchange between regional health
information organizations
Provides access to external sources of information including web-based
resources
Facilitates acquisition of Meaningful Use and other required health
reports and statistics including: ability to prompt, capture, analyze,
and report; smoking cessation; avoidable medical errors; and readmissions
Field communications hub for discharge/health care provider deployment
Patient specific configuration
Biometric peripheral wi-fi communications
global positioning system (GPS) patient tracking
Video teleconferencing
Patient disease management plan
Personal Emergency Response System (PERS)
Nutritional regimen
Inventory
Supply deliveries
Scheduled future supply deliveries

### Use of the Invention in Selecting Subjects for Clinical Trials.

The system of the invention, and methods of using the same, as useful for selecting candidates for clinical trials. The ability of the system of the invention to search for genetic and genomic of a potential subject and compare that information with the genetic and genomic information of a population allows the invention to search for candidates for clinical trials who possess genetic information useful for the purpose of the trial.

The system of the invention, and methods of using the same, can be used in the design of a clinical trial protocol. The system of the invention combines several means to access, retrieve, process, and display information from existing genomic databases of individuals being considered for: a) participation in pre-clinical development trial, b) inclusion in a clinical trial protocol, and/or c) continued participation in a clinical trial protocol.

Clinical trials typically proceed through several steps, including pre-clinical studies, pilot studies, safety screening studies, efficacy evaluation studies, and patient enrollment all of which are essential for a clinical trial protocol to succeed. Non-limiting examples of applications of the invention in a clinical trial include analysis of genetic or genomic information of individual(s) being considered for inclusion in the trial. Genetic and genomic evaluation by the system of the invention can also be used to assign participants to standard-of-care treatment groups, placebo treatment groups, and to optimize dosing of drug treatments.

For a drug to be approved and marketed, all milestones specified in a clinical trial protocol must be met, including, for example, demonstration of efficacy within a proposed confidence interval, and inclusion of a significant number of individuals to demonstrate the statistical power of the invention. Non-limiting examples of applications of the system of the invention include the means to access, retrieve, and display information of individuals being considered for enrollment in a clinical trial. Selection of individuals based on genetic or genomic information can contribute to the outcome of a clinical trial.

The system of the invention can be used to access, retrieve, process, display data and information from a plurality of independent data and information sources in the hypothesis formation (preclinical) stages of a clinical trial. The invention permits users to evaluate the genetic and genomic information of individuals who could become participants in a clinical trial and guide the hypothesis-forming steps of a clinical trial protocol.

In some embodiments, systems of the invention can be used to screen individuals for enrollment in a clinical trial protocol. In some embodiments, systems of the invention can be used as a guide for the determination of optimum drug dosage in any stage of a clinical trial protocol.

Clinical studies have standards outlining who can participate, called eligibility criteria, which are listed in the protocol. Some research studies seek participants who have a known genotype, phenotype, haplotype, diplotype, genetic nucleic acid sequence homology, chromosomal copy number, genomic copy number, or a polymorphism of interest. Other studies seek healthy participants. Some clinical trial protocols are limited to a predetermined group of people who are solicited by researchers to enroll. The systems of the invention can correlate such data and information from a plurality of independent data and information sources and increase the likelihood that eligible participants for a clinical trial are identified.

The system of the invention can be used to determine clinical trial candidate eligibility criteria. The eligibility criteria evaluated by the invention can be, for example, inclusion or exclusion criteria.

Systems of the invention can be used to evaluate electronic medical records data in near-real-time to inform the progress of a clinical trial. A non-limiting example is generation of a near-real-time summary of positive and adverse reactions of a therapeutic candidate. The ability of the systems of the invention to process and summarize ongoing data points can lead to faster evaluation of drugs by physicians, scientists, and the FDA.

### Computer System Architectures.

The systems and methods described herein are compatible with a wide scope of computer systems, platforms, and technologies. Non-limiting examples of suitable computer systems include stand-alone systems, local networks, global networks, and servers with local and/or remote access. For example, a system of the invention can operate under control of a client system.

In some embodiments, a device capable of operating a system of the invention is a telecommunications device. In some embodiments, the device is hand-held. Non-limiting examples of suitable devices include telephones, personal data assistants, and computers. In some embodiments, the device acts as a client capable of simultaneously accessing a plurality of unrelated servers. In some embodiments, the client can process information received from a plurality of servers to arrive at a result that could not be obtained from any one of the plurality of servers. Non-limiting examples of the result include data, a diagnosis, a comparison, a recommendation, a correlation, a prediction, a trend, and an alert.

In some embodiments, the device functions effectively without application code that understands the meaning, or the original context, of the source data. In some embodiments, the device functions effectively without the need for the query tools that can interpret or reference a boundary descriptor or a format of one or more data systems. In some embodiments, the device functions effectively without application code that is compatible with the meaning, or the original context, of the source data. In some embodiments, the device functions effectively without application code that interfaces with the meaning, or the original context, of the source data. In some embodiments, the device functions effectively without application code that is the same as the application code of the source data. In some embodiments, a device and/or system of the invention use a code that is different from the code used by the independent data or information sources. In some embodiments, the device and/or system of the invention uses a first code, the independent data or information sources use a second code, and the first code and the second code are not the same.

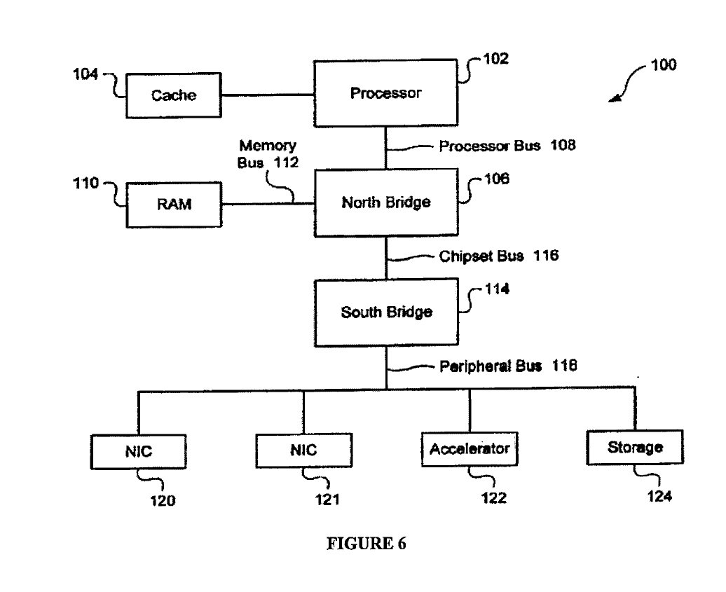

FIG. 6 is a block diagram illustrating a first example architecture of a computer system 100 that can be used in connection with example embodiments of the present invention. As depicted in FIG. 6, the example computer system can include a processor (102) for processing instructions. Non-limiting examples of processors include: Intel Xeon™ processor, AMD Opteron™ processor, Samsung 32-bit RISC ARM 1176JZ(F)-S v1.0™ processor, ARM Cortex-A8 Samsung S5PC100™ processor, ARM Cortex-A8 Apple A4™ processor, Marvell PXA 930™ processor, or a functionally-equivalent processor. Multiple threads of execution can be used for parallel processing. In some embodiments, multiple processors or processors with multiple cores can also be used, whether in a single computer system, in a cluster, or distributed across systems over a network comprising a plurality of computers, cell phones, and/or personal data assistant devices.

As illustrated in FIG. 6, a high speed cache (104) can be connected to, or incorporated in, the processor (102) to provide a high speed memory for instructions or data that have been recently, or are frequently, used by processor (102). The processor (102) is connected to a north bridge (106) by a processor bus (108). The north bridge (106) is connected to random access memory (RAM; 110) by a memory bus (112) and manages access to the RAM (110) by the processor (102). The north bridge (106) is also connected to a south bridge (114) by a chipset bus (116). The south bridge (114) is, in turn, connected to a peripheral bus (118). The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus (118). In some alternative architectures, the functionality of the north bridge can be incorporated into the processor instead of using a separate north bridge chip.

In some embodiments, system (100) can include an accelerator card (122) attached to the peripheral bus (118). The accelerator can include field programmable gate arrays (FPGAs) or other hardware for accelerating certain processing. For example, an accelerator can be used for adaptive data restructuring or to evaluate algebraic expressions used in extended set processing.

Software and data are stored in external storage (124) and can be loaded into RAM (110) and/or cache (104) for use by the processor. The system (100) includes an operating system for managing system resources; non-limiting examples of operating systems include: Linux, Windows™, MACOS™, BlackBerry OS™, iOS™, and other functionally-equivalent operating systems, as well as application software running on top of the operating system for managing data storage and optimization in accordance with example embodiments of the present invention.

In this example, system (100) also includes network interface cards (NICs; 120 and 121) connected to the peripheral bus for providing network interfaces to external storage, such as Network Attached Storage (NAS) and other computer systems that can be used for distributed parallel processing.

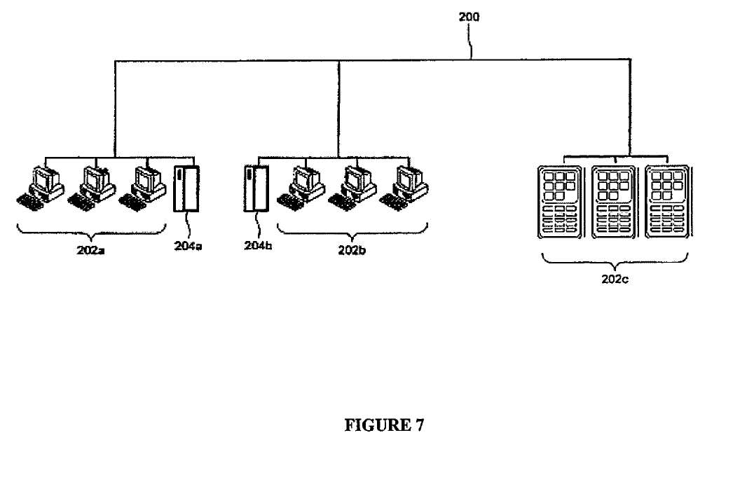

FIG. 7 is a diagram showing a network (200) with a plurality of computer systems (202a, and 202b), a plurality of cell phones and personal data assistants (202c), and Network Attached Storage (NAS; 204a and 204b). In example embodiments, the systems (202a; 202b; and 202c) can manage data storage and optimize data access for data stored in NAS (204a and 204b). A mathematical model can be used for the data and be evaluated using distributed parallel processing across computer systems (202a, and 202b), and cell phone and personal data assistant systems (202c). Computer systems (202a, and 202b), and cell phone and personal data assistant systems (202c) can also provide parallel processing for adaptive data restructuring of the data stored in NAS (204a and 204b). FIG. 7 illustrates an example only, and a wide variety of other computer architectures and systems can be used in conjunction with the various embodiments of the present invention. For example, a blade server can be used to provide parallel processing. Processor blades can be connected through a back plane to provide parallel processing. Storage can also be connected to the back plane or as Network Attached Storage (NAS) through a separate network interface.

In some example embodiments, processors can maintain separate memory spaces and transmit data through network interfaces, back plane or other connectors for parallel processing by other processors. In other embodiments, some or all of the processors can use a shared virtual address memory space.

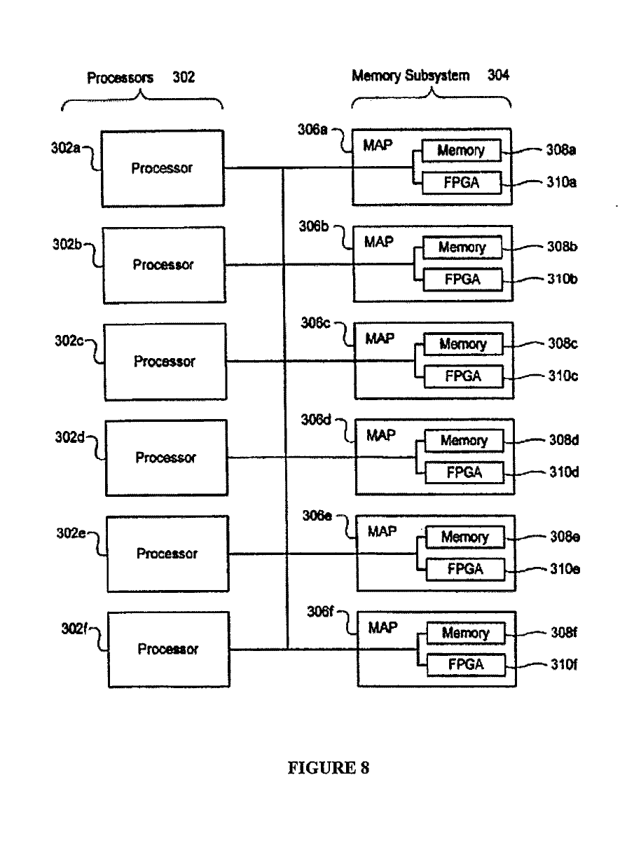

FIG. 8 is a block diagram of a multiprocessor computer system (300) using a shared virtual address memory space in accordance with an example embodiment. The system includes a plurality of processors (302a-f) that can access a shared memory subsystem (304). The system incorporates a plurality of programmable hardware memory algorithm processors (MAPs; 306a-f) in the memory subsystem (304). Each MAP (306a-f) can comprise a memory (308a-f) and one or more field programmable gate arrays (FPGAs; 310a-f). The MAP provides a configurable functional unit and particular algorithms or portions of algorithms can be provided to the FPGAs (310a-f) for processing in close coordination with a respective processor. For example, the MAPs can be used to evaluate algebraic expressions regarding the data model and to perform adaptive data restructuring in example embodiments. In this example, each MAP is globally accessible by all of the processors for these purposes. In one configuration, each MAP can use Direct Memory Access (DMA) to access an associated memory (308a-f), allowing it to execute tasks independently of, and asynchronously from, the respective microprocessor (302a-f). In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example embodiments, including systems using any combination of general processors, co-processors, FPGAs and other programmable logic devices, system on chips (SOCs), application specific integrated circuits (ASICs), and other processing and logic elements. In some embodiments, all or part of the data management and optimization system can be implemented in software or hardware and that any variety of data storage media can be used in connection with example embodiments, including random access memory, hard drives, flash memory, tape drives, disk arrays, Network Attached Storage (NAS) and other local or distributed data storage devices and systems.

In example embodiments, the data management and optimization system can be implemented using software modules executing on any of the above or other computer architectures and systems. In other embodiments, the functions of the system can be implemented partially or completely in firmware, programmable logic devices such as field programmable gate arrays (FPGAs) as referenced in FIG. 8, system on chips (SOCs), application specific integrated circuits (ASICs), or other processing and logic elements. For example, the Set Processor and Optimizer can be implemented with hardware acceleration through the use of a hardware accelerator card, such as accelerator card (122) illustrated in FIG. 6.

In some embodiments, the invention provides a computer system for searching a genomic database, the computer system comprising: a) a processor; b) a core comprising: 1) a rule engine; 2) a core faceted search engine; and 3) a core index; c) one or more genomic databases operably connected to the core index; and d) a plugin operably connected to the core. In some embodiments, the computer system further comprises: e) one or more data interfaces, each comprising: 1) a peripheral faceted search engine; and 2) a peripheral index, wherein each data interface is operably connected to the core; and f) one or more sources of clinical information or data, wherein each source is operably connected to at least one data interface. In some embodiments, each data interface is connected to the core by the core faceted search engine. In some embodiments, at least one data interface and the core are at a same site. In some embodiments, at least one data interface is at a site remote from the core. In some embodiments, the sources of clinical information or data comprise an electronic medical record, an electronic pharmacy record, a medical history, a medical record database, a medical legacy silo, a patient record, a medical monitoring device, a laboratory database, a reference manual, a genetic sequence, a genomic record, a homology map, a result of a restriction fragment length polymorphism test, a result of a polymerase chain reaction test, a result of a paternity test, or a genetic signature. In some embodiments, the sources of clinical information or data have schema that are the same, similar, or different. In some embodiments, the computer system does not map any portion of the peripheral indices to the sources. In some embodiments, the computer system does not map any portion of the core index to the genomic databases. In some embodiments, the computer system does not download or store information. In some embodiments, the computer system can be operated by a personal computer, a personal data assistant, or a cellular phone. In some embodiments, the computer system provides graphical descriptions of data.

In some embodiments, the invention provides a method of searching a genomics database on a computer system, the computer system comprising: a) a processor; b) a core comprising: 1) a rule engine; 2) a core faceted search engine; and 3) a core index; c) one or more genomic databases operably connected to the core index; and d) a plugin operably connected to the core, wherein the method comprises using the plugin to submit a first query to the core faceted search engine, and wherein upon submission of the first query: A) the core index accesses data stored in the databases and compiles the data within the core index; and B) the core faceted search engine performs a faceted search of the core index leading to a first search result. In some embodiments, the computer system autonomously resubmits the first query at a user-determined time interval. In some embodiments, the first query comprises a subject's identity, a population's identity, a genome, a gene, an allele, a nucleic acid sequence, a mutation, a polymorphism, a gene function, a physiological pathway, a phenotype, a result of a restriction fragment length polymorphism test, a result of a polymerase chain reaction test, a result of a paternity test, a clinical value, a subject characteristic, or a population characteristic. In some embodiments, the phenotype is drug resistance, drug susceptibility, disease resistance, or disease susceptibility. In some embodiments, the computer system provides the first search result to a user. In some embodiments, the first search result comprises a subject's identity, a population's identity, a genome, a gene, an allele, a nucleic acid sequence, a mutation, a polymorphism, a gene function, a physiological pathway, a phenotype, a result of a restriction fragment length polymorphism test, a result of a polymerase chain reaction test, a result of a paternity test, a clinical value, a subject characteristic, or a population characteristic. In some embodiments, the phenotype is drug resistance, drug susceptibility, disease resistance, or disease susceptibility. In some embodiments, the method further comprises using the plugin to submit a second query to the core faceted search engine, leading to a second search result. In some embodiments, the method further comprises using the plugin to submit additional queries to the core faceted search engine, leading to additional search results. In some embodiments, the method further comprises using the plugin to submit a rule to the rule engine, wherein the rule instructs the computer system to perform an operation on the first search result and the second search result, thereby producing a final search result. In some embodiments, the computer system provides the final search result to a user. In some embodiments, the final search result comprises a subject's identity, a population's identity, a genome, a gene, an allele, a nucleic acid sequence, a mutation, a polymorphism, a gene function, a physiological pathway, a phenotype, a result of a restriction fragment length polymorphism test, a result of a polymerase chain reaction test, a result of a paternity test, a clinical value, a subject characteristic, or a population characteristic. In some embodiments, the phenotype is drug resistance, drug susceptibility, disease resistance, or disease susceptibility.

In some embodiments, the invention provides a method of searching for a subject's genetic information in one or more populations using a computer system, the computer system comprising: a) a processor; b) a core comprising: 1) a rule engine; 2) a core faceted search engine; and 3) a core index; c) one or more genomic databases operably connected to the core index, wherein each genomic database contains the genetic information of at least one population; and d) a plugin operably connected to the core, wherein the method comprises using the plugin to submit a first query to the core faceted search engine, wherein the first query contains the subject's genetic information, and wherein upon submission of the first query: A) the core index accesses data stored in the databases and compiles the data within the core index; and B) the core faceted search engine performs a faceted search of the core index leading to a first search result. In some embodiments, the computer system autonomously resubmits the first query at a user-determined time interval. In some embodiments, the subject's genetic information is a genome, a gene, an allele, or a nucleic acid sequence, a mutation, a polymorphism, a gene function, a physiological pathway, a result of a restriction fragment length polymorphism test, a result of a polymerase chain reaction test, a result of a paternity test. In some embodiments, the computer system provides the first search result to a user. In some embodiments, the first search result comprises an output information of the population. In some embodiments, the output information is a genome, a gene, an allele, a nucleic acid sequence, a mutation, a polymorphism, a gene function, a physiological pathway, an identity of an individual, an identity of a subpopulation, a cross-section of the population, or a statistical analysis of the population. In some embodiments, the output information is associated with a phenotype. In some embodiments, the phenotype is drug resistance, drug susceptibility, disease resistance, or disease susceptibility. In some embodiments, the method further comprises comparing the output information to the subject's genetic information. In some embodiments, the method further comprises predicting a phenotype of the subject based on the comparison of the output information to the subject's genetic information. In some embodiments, the method further comprises diagnosing the subject based on the comparison. In some embodiments, the method further comprises using the plugin to submit a second query to the core faceted search engine, leading to a second search result. In some embodiments, the method further comprises using the plugin to submit additional queries to the core faceted search engine, leading to additional search results. In some embodiments, the method further comprises using the plugin to submit a rule to the rule engine, wherein the rule instructs the computer system to perform an operation on the first search result and the second search result, thereby producing a final search result. In some embodiments, the computer system provides the final search result to a user. In some embodiments, the final search result comprises an identity of an individual, an identity of a subpopulation, a cross-section of the population, or a statistical analysis of the population.

In some embodiments, the invention provides a method of comparing one or more subjects' clinical information to a genetic information of one or more populations using a computer system, the computer system comprising: a) a processor; b) a core comprising: 1) a rule engine; 2) a core faceted search engine; and 3) a core index; c) one or more genomic databases operably connected to the core index, wherein each genomic database contains the genetic information of at least one population; d) a plugin operably connected to the core; e) one or more data interfaces, each comprising: 1) a peripheral faceted search engine; and 2) a peripheral index, wherein each data interface is operably connected to the core; and f) one or more sources of clinical information or data about the subjects, wherein each source is operably connected to at least one data interface, wherein the method comprises using the plugin to submit a first query to the computer system, wherein upon submission of the first query: A) the core index accesses data stored in the databases and compiles the data within the core index; B) the core faceted search engine performs a faceted search of the core index leading to a core search result comprising the genetic information of the population; C) each peripheral index accesses the clinical information or data stored in the sources and compiles the clinical information or data within one of the peripheral indices; D) each peripheral faceted search engine performs a faceted search of at least one of the peripheral indices, each peripheral faceted search leading to a peripheral search result comprising the subject's clinical information; and E) the core performs a federated query of each peripheral search result, whereby the core search result and each peripheral search result are compared, leading to a first search result. In some embodiments, the computer system provides the first search result to a user. In some embodiments, the sources of clinical information or data comprise an electronic medical record, an electronic pharmacy record, a medical history, a medical record database, a medical legacy silo, a patient record, a medical monitoring device, a laboratory database, a reference manual, a genetic sequence, a genomic record, a homology map, a result of a restriction fragment length polymorphism test, a result of a polymerase chain reaction test, a result of a paternity test, or a genetic signature. In some embodiments, the subject's clinical information comprises a subject's identity, the subject's genetic information, a phenotype, a clinical value, or a subject characteristic. In some embodiments, the subject's genetic information is a genome, a gene, an allele, a nucleic acid sequence, a mutation, a polymorphism, a gene function, or a physiological pathway. In some embodiments, the phenotype is drug resistance, drug susceptibility, disease resistance, or disease susceptibility. In some embodiments, the first search result identifies an individual or a subpopulation that shares a similarity with the subject, wherein the similarity is a shared genetic information, a shared phenotype, a shared clinical value, or a shared subject characteristic. In some embodiments, the shared phenotype is drug resistance, drug susceptibility, disease resistance, or disease susceptibility. In some embodiments, the shared genetic information is a genome, a gene, an allele, a nucleic acid sequence, a mutation, a polymorphism, a gene function, a physiological pathway, a result of a restriction fragment length polymorphism test, a result of a polymerase chain reaction test, or a result of a paternity test. In some embodiments, the method further comprises diagnosing the subject based on the comparison of step E. In some embodiments, the method further comprises using the plugin to submit a rule to the rule engine. In some embodiments, the rule instructs the computer system to perform an operation on the search result. In some embodiments, the method further comprises using the plugin to submit a second query to the core faceted search engine, leading to a second search result. In some embodiments, the method further comprises using the plugin to submit additional queries to the core faceted search engine, leading to additional search results. In some embodiments, the method further comprises using the plugin to submit a rule to the rule engine, wherein the rule instructs the computer system to perform an operation on the first search result and the second search result, thereby producing a final search result.

In some embodiments, the invention provides a method of selecting subjects for a clinical trial associated with a disease using a computer system, the computer system comprising: a) a processor; b) a core comprising: 1) a rule engine; 2) a core faceted search engine; and 3) a core index; c) one or more genomic databases operably connected to the core index, wherein each genomic database contains the genetic information of at least one population; d) a plugin operably connected to the core, e) one or more data interfaces, each comprising: 1) a peripheral faceted search engine; and 2) a peripheral index, wherein each data interface is operably connected to the core; and f) one or more sources of clinical information or data about the subjects, wherein each source is operably connected to at least one data interface, wherein the method comprises using the plugin to: A) query the core for a genetic information associated with the disease, wherein upon submission of the query: i) the core index accesses data stored in the databases and compiles the data within the core index; and ii) the core faceted search engine performs a faceted search of the core index leading to a core search result containing the genetic information associated with the disease; B) submit a plurality of queries to each data interface, wherein each query indicates a clinical trial inclusion criterion, wherein at least one inclusion criterion is the genetic information associated with the disease, whereupon: i) each peripheral index access the clinical information or data stored in at least one of the sources and compiles the clinical information or data within the peripheral index; and ii) each peripheral faceted search engine performs a peripheral faceted search of at least one of the peripheral indices for each of the plurality of queries, each peripheral faceted search leading to a peripheral search result, wherein each peripheral search result indicates a group of subjects meeting one inclusion criterion; C) submit a federated query to the core, whereby all groups of subjects meeting one inclusion criterion are reported to the core; and D) submit at least one rule to the rule engine, wherein the rule compares the groups of subjects meeting one inclusion criterion to identify a list of subjects meeting all inclusion criteria, wherein the method further comprises selecting subjects for the clinical trial based on the list of subjects. In some embodiments, the genetic information associated with the disease is a genome, a gene, an allele, a nucleic acid sequence, a mutation, a polymorphism, a gene function, or a physiological pathway.

In some embodiments, the invention provides a method of performing a federated search for genetic information, the method comprising submitting a first query to a computer system comprising a processor and a core, wherein: a) the core distributes the first query to one or more data interfaces; b) each data interface executes a peripheral faceted search on one or more sources of clinical information or data to produce a plurality of federated search results, wherein at least one federated search result comprises genetic information; c) each data interface reports the federated search results to the core; and d) the core reports the federated search results to a user. In some embodiments, the core executes a core faceted search on a database of genomic information to provide a core search result. In some embodiments, the core comprises a rule engine that executes a rule on the federated search results. In some embodiments, the sources of clinical information or data comprise an electronic medical record, an electronic pharmacy record, a medical history, a medical record database, a medical legacy silo, a patient record, a medical monitoring device, a laboratory database, a reference manual, a genetic sequence, a genomic record, a homology map, a result of a restriction fragment length polymorphism test, a result of a polymerase chain reaction test, a result of a paternity test, or a genetic signature. In some embodiments, the computer system does not download or store information. In some embodiments, the computer system can be operated by a personal computer, a personal data assistant, or a cellular phone. In some embodiments, the computer system autonomously resubmits the first query at a user-determined time interval. In some embodiments, the first query comprises a subject's identity, a population's identity, a genome, a gene, an allele, a nucleic acid sequence, a mutation, a polymorphism, a gene function, a physiological pathway, a phenotype, a result of a restriction fragment length polymorphism test, a result of a polymerase chain reaction test, a result of a paternity test, a clinical value, a subject characteristic, or a population characteristic. In some embodiments, the phenotype is drug resistance, drug susceptibility, disease resistance, or disease susceptibility. In some embodiments, the method further comprises submitting a second query to the core. In some embodiments, the method further comprises submitting additional queries to the core. In some embodiments, the core comprises a rule engine, the method further comprising submitting a rule to the rule engine, wherein the rule instructs the computer system to perform an operation on the first query and the second query, thereby producing a final search result. In some embodiments, the final search result comprises a subject's identity, a population's identity, a genome, a gene, an allele, a nucleic acid sequence, a mutation, a polymorphism, a gene function, a physiological pathway, a phenotype, a clinical value, a subject characteristic, or a population characteristic. In some embodiments, the phenotype is drug resistance, drug susceptibility, disease resistance, or disease susceptibility. In some embodiments, the computer system compares each federated search result to the core search result. In some embodiments, the core search result identifies an individual or a population that shares a similarity with at least one federated search result, wherein the similarity is a shared genetic information, a shared phenotype, a shared clinical value, or a shared subject characteristic. In some embodiments, the shared phenotype is drug resistance, drug susceptibility, disease resistance, or disease susceptibility. In some embodiments, the shared genetic information is a genome, a gene, an allele, a nucleic acid sequence, a mutation, a polymorphism, a gene function, a physiological pathway, a result of a restriction fragment length polymorphism test, a result of a polymerase chain reaction test, or a result of a paternity test. In some embodiments, one of the federated search results identifies a subject, and the subject is diagnosed based on the similarity with the individual or population. In some embodiments, the core search result is a clinical trial inclusion criterion, the federated search result is a subject, and the subject is accepted or rejected as a clinical trial candidate based on the comparison.

### EXAMPLES

### Example 1

### A System of the Invention is Used to Identify Candidates for Inclusion in a Clinical Trial

The trial involves a multicenter, phase I dose escalation trial of vemurafenib for the treatment of malignant melanoma. The genetic component for trial inclusion is the presence of the BRAF V600E mutation. Additional clinical inclusion criteria for this trial includes: i. age of at least eighteen years; ii. histological confirmation of solid tumors; iii. refractory response to standard therapy; iv. Eastern Cooperative Oncology Group performance status score of 0 or 1; v. life expectancy of three months or longer; and vi. adequate hematologic, hepatic, and renal function.

Rules are defined to tag subjects based on data relevant to the clinical trial, including: the presence of the BRAF V600E mutation; demographics; and histology. To define a rule to determine if a subject meets the criteria for the clinical trial, queries are defined to identify subjects that meet individual trial inclusion criteria. Each query is performed via faceted search on a peripheral index storing the totality of the clinical data for all possible subjects, including genomic data, such as, all the somatic variants present in a subject's cancer. Each query retrieves a distinct class of data elements. The results of the queries are then intersected based on subject identity to identify subjects meeting the trial inclusion criteria.

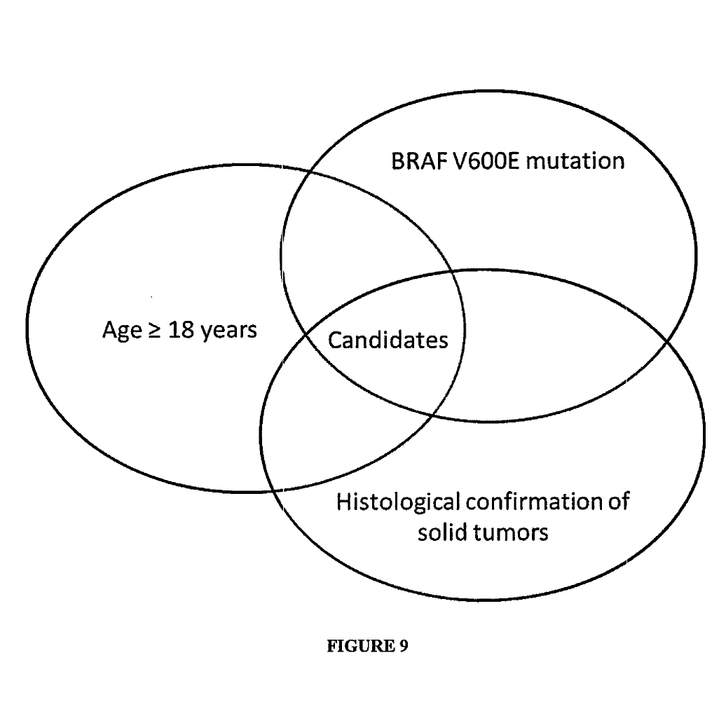

FIG. 9 illustrates a Venn diagram of the results of three queries. The three groups represent subjects that possess: 1) age of at least eighteen years; 2) the BRAF V600E mutation; and 3) histological confirmation of solid tumors. Potential trial candidates lie at the intersection of the three groups.

After identifying a potential trial candidate, a supervising physician investigates whether the subject meets additional trial inclusion criteria. For additional criteria, subjects are identified as: i. pass; ii. fail; or iii. unknown, based on available clinical data. For example, to determine adequate renal function, the result of a recent creatinine clearance test is used. Subjects with good creatinine clearance are identified as passing, and subjects with poor creatinine clearance are identified as failing. Subjects without a creatinine clearance test are identified as unknown.

### EMBODIMENTS

The following non-limiting embodiments provide representative examples of the invention, but do not limit the scope of the invention.

### Embodiment 1

A method comprising: a) submitting a first query comprising a phenotype to search a genomic database to provide a first search result comprising a genetic information associated with the phenotype; b) submitting a second query to search a medical records database, wherein the second query is based on the genetic information, to provide a second search result comprising a set of electronic medical records, wherein each electronic medical record in the set is associated with the genetic information; and c) selecting or rejecting a candidate for the clinical trial based on the electronic medical records, wherein the searches are performed by a computer comprising a processor.

### Embodiment 2

The method of Embodiment 1, further comprising reporting the second search result over a network or an internet.

### Embodiment 3

The method of any one of Embodiments 1-2, wherein the computer automatically submits the second query upon receiving the first search result.

### Embodiment 4

The method of any one of Embodiments 1-3, wherein the computer automatically resubmits the first query at a time interval.

### Embodiment 5

The method of any one of Embodiments 1-4, wherein the searches search more than one dimension of taxonomy.

### Embodiment 6

The method of any one of Embodiments 1-5, wherein the genomic database and the medical records database have organizational schema that are different.

### Embodiment 7

The method of any one of Embodiments 1-6, wherein the phenotype is a disease.

### Embodiment 8

The method of any one of Embodiments 1-7, wherein the phenotype is drug resistance, drug susceptibility, disease resistance, or disease susceptibility.

### Embodiment 9

The method of any one of Embodiments 1-8, wherein the genetic information is a nucleic acid sequence.

### Embodiment 10

The method of any one of Embodiments 1-9, wherein the genetic information is a polymorphism.

### Embodiment 11

A method comprising: a) submitting a first query comprising a phenotype to search a genomic database to provide a first search result comprising a genetic information associated with the phenotype; b) submitting a second query to search a medical records database, wherein the second query is based on the genetic information, to provide a second search result comprising a first set of electronic medical records, wherein each electronic medical record in the first set is associated with the genetic information; c) submitting a third query to search the medical records database, wherein the third query comprises a clinical trial inclusion criterion, to provide a third search result comprising a second set of electronic medical records, wherein each electronic medical record in the second set is associated with the clinical trial inclusion criterion; d) applying a logic operation to the first set of electronic medical records and the second set of electronic medical records to provide a final set of electronic medical records; and e) selecting or rejecting a candidate for the clinical trial based on the final set of electronic medical records, wherein the searches are performed by a computer comprising a processor.

### Embodiment 12

The method of Embodiment 11, further comprising reporting the final set of electronic medical records over a network or an internet.

### Embodiment 13

The method of any one of Embodiments 11 and 12, wherein the computer automatically submits the second query and the third query upon receiving the first search result.

### Embodiment 14

The method of any one of Embodiments 11-13, wherein the computer automatically resubmits the first query at a time interval.

### Embodiment 15

The method of any one of Embodiments 11-14, wherein the searches search more than one dimension of taxonomy.

### Embodiment 16

The method of any one of Embodiments 11-15, wherein the genomic database and the medical records database have organizational schema that are different.

### Embodiment 17

The method of any one of Embodiments 11-16, wherein the phenotype is a disease.

### Embodiment 18

The method of any one of Embodiments 11-17, wherein the phenotype is drug resistance, drug susceptibility, disease resistance, or disease susceptibility.

### Embodiment 19

The method of any one of Embodiments 11-18, wherein the genetic information is a nucleic acid sequence.

### Embodiment 20

The method of any one of Embodiments 11-19, wherein the genetic information is a polymorphism.

What is claimed is:

1. A method of identifying clinical trial candidates, the method comprising:
a) submitting a first query comprising a phenotype to search a genomic database to provide a first search result comprising a genetic information associated with the phenotype;
b) submitting a second query to search a medical records database, wherein the second query is based on the genetic information, to provide a second search result comprising a set of electronic medical records, wherein each electronic medical record in the set is associated with the genetic information; and
c) selecting or rejecting a candidate for the clinical trial based on the electronic medical records,
wherein the searches are performed by a computer comprising a processor.

2. The method of claim 1, further comprising reporting the second search result over a network or an internet.

3. The method of claim 1, wherein the computer automatically submits the second query upon receiving the first search result.

4. The method of claim 1, wherein the computer automatically resubmits the first query at a time interval.

5. The method of claim 1, wherein the searches search more than one dimension of taxonomy.

6. The method of claim 1, wherein the genomic database and the medical records database have organizational schema that are different.

7. The method of claim 1, wherein the phenotype is a disease.

8. The method of claim 1, wherein the phenotype is drug resistance, drug susceptibility, disease resistance, or disease susceptibility.

9. The method of claim 1, wherein the genetic information is a nucleic acid sequence.

10. The method of claim 1, wherein the genetic information is a polymorphism.

11. A method of identifying clinical trial candidates, the method comprising:
a) submitting a first query comprising a phenotype to search a genomic database to provide a first search result comprising a genetic information associated with the phenotype;
b) submitting a second query to search a medical records database, wherein the second query is based on the genetic information, to provide a second search result comprising a first set of electronic medical records, wherein each electronic medical record in the first set is associated with the genetic information;
c) submitting a third query to search the medical records database, wherein the third query comprises a clinical trial inclusion criterion, to provide a third search result comprising a second set of electronic medical records, wherein each electronic medical record in the second set is associated with the clinical trial inclusion criterion;
d) applying a logic operation to the first set of electronic medical records and the second set of electronic medical records to provide a final set of electronic medical records; and
e) selecting or rejecting a candidate for the clinical trial based on the final set of electronic medical records,
wherein the searches are performed by a computer comprising a processor.

12. The method of claim 11, further comprising reporting the final set of electronic medical records over a network or an internet.

13. The method of claim 11, wherein the computer automatically submits the second query and the third query upon receiving the first search result.

14. The method of claim 11, wherein the computer automatically resubmits the first query at a time interval.

15. The method of claim 11, wherein the searches search more than one dimension of taxonomy.

16. The method of claim 11, wherein the genomic database and the medical records database have organizational schema that are different.

17. The method of claim 11, wherein the phenotype is a disease.

18. The method of claim 11, wherein the phenotype is drug resistance, drug susceptibility, disease resistance, or disease susceptibility.

19. The method of claim 11, wherein the genetic information is a nucleic acid sequence.

20. The method of claim 11, wherein the genetic information is a polymorphism.
